(19) United States
(12) Patent Application Publication
(10) Pub. No.: US 2022/0309400 A1
(43) Pub. Date: Sep. 29, 2022

(54) LEARNING METHOD, LEARNING DEVICE, AND RECORDING MEDIUM

(71) Applicant: Panasonic Intellectual Property Management Co., Ltd., Osaka (JP)

(72) Inventor: Kazuhiro WAKE, Osaka (JP)

(21) Appl. No.: 17/701,560

(22) Filed: Mar. 22, 2022

(30) Foreign Application Priority Data
Mar. 24, 2021 (JP) 2021-050042

(51) Int. Cl. G06N 20/00; G06V 10/764; G06V 10/776; G06T 7/70

(52) U.S. Cl. CPC G06N 20/00; G06V 10/764; G06V 10/776; G06T 7/70; G06T 2207/30261

(57) ABSTRACT

A learning method includes acquiring a learning image including an object, and correct information including a correct class a correct box; calculating an evaluation value for a learning model in accordance with a difference between the correct information and an object detection result that includes a detected class and a detected box and that is obtained by inputting the learning image to the learning model; and adjusting parameters of the learning model in accordance with the evaluation value, The calculating of the evaluation value includes performing at least one of processing for varying a weight that is assigned to each of differences of two or more positions or lengths between the correct box and the detected box, or processing for varying a weight that is assigned to a difference between the correct class and the detected class.

### CROSS REFERENCE TO RELATED APPLICATION

The present application is based on and claims priority of Japanese Patent Application No. 2021-050042 filed on Mar. 24, 2021.

### FIELD

The present disclosure relates to a learning method, a learning device, and a recording medium.

### BACKGROUND

In recent years, the number of vehicles equipped with a collision damage reduction brake has been increasing and is expected to increase further in the future in order to prevent the occurrence of accidents during driving. To realize the collision damage reduction brake, an object detector is known that detects objects around vehicles, using image data captured by an on-vehicle camera or any other device. Since vehicle runs are controlled based on an object detection result obtained from the object detector, it is desirable for the object detector to have high detection accuracy.

Such an object detector uses a learning model that is trained by machine learning for object detection. For example, a single shot multibox detector (SSD) is known as an algorithm for object detection (see NPL 1).

### CITATION LIST

### Non Patent Literature

NPL1: Wei Liu et al., “SSD: Single Shot MultiBox Detector”, Internet <URL:https://arxiv.org/pdf/1512.02325.pdf>

### SUMMARY

The technique disclosed in NPL 1, however, can be improved upon.

In view of this, the present disclosure provides a learning method, a learning device, and a recording medium that are capable of further improvement.

A learning method according to one aspect of the present disclosure include acquiring a learning image and correct information, the learning image including an object, the correct information including a correct class and a correct box, the correct class indicating a class of the object, and the correct box indicating a region that includes the object in the learning image, acquiring an object detection result and calculating an evaluation value for a learning model in accordance with a difference between the correct information and the object detection result acquired, the learning model being a model that receives input of an image and outputs the object detection result, the object detection result including a detected class and a detected box, the detected class indicating a class of the object obtained by inputting the learning image to the learning model, and the detected box indicating a region that includes the object in the learning image, and adjusting a parameter of the learning model in accordance with the evaluation value calculated. The calculating of the evaluation value includes performing at least one of processing for varying a weight that is assigned to each of differences of two or more positions or two or more lengths between the correct box and the detected box, or processing for varying a weight that is assigned to a difference between the correct class and the detected class, in accordance with whether the correct class is a specific class.

A learning device according to one aspect of the present disclosure includes an acquirer that acquires a learning image and correct information, the learning image including an object, the correct information including a correct class and a correct box, the correct class indicating a class of the object, and the correct box indicating a region that includes the object in the learning image, an evaluator that acquires an object detection result and calculates an evaluation value for a learning model in accordance with a difference between the correct information and the object detection result acquired, the learning model being a model that receives input of an image and outputs the object detection result, the object detection result including a detected class and a detected box, the detected class indicating the class of the object obtained by inputting the learning image to the learning model, and the detected box indicating a region that includes the object in the learning image, and an adjuster that adjusts a parameter of the learning model in accordance with the evaluation value calculated. In the calculating of the evaluation value, the evaluator performs at least one of processing for varying a weight that is assigned to each of differences of two or more positions or two or more lengths between the correct box and the detected box, or processing for varying a weight that is assigned to a difference between the correct class and the detected class, in accordance with whether the correct class is a specific class.

A recording medium according to one aspect of the present disclosure is a non-transitory computer-readable recording medium having recorded thereon a program for causing a computer to execute the learning method described above.

According to one aspect of the present disclosure, it is possible to achieve a learning method and so on that have undergone further improvement.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic diagram for describing position estimation conducted by a vehicle according to a comparative example.

FIG. 2 is a block diagram illustrating a functional configuration of a position estimation system according to Embodiment 1.

FIG. 3 shows one example of a position estimation result.

FIG. 4 is a block diagram illustrating a functional configuration of a learning device for position estimation according to Embodiment 1.

FIG. 5 is a flowchart of operations of the learning device according to Embodiment 1.

FIG. 6A illustrates a correct box provided during learning carried out by the learning device.

FIG. 6B illustrates an estimated box output during learning carried out by the learning device.

FIG. 6C illustrates a deviation of the estimated box from the correct box during learning carried out by the learning device.

FIG. 7 is a diagram for describing a parameter adjustment method used in an adjustor according to Embodiment 1.

FIG. 8 illustrates a class that is detected by a position estimation device according to Embodiment 2.

FIG. 9 is a flowchart illustrating operations of a learning device according to Embodiment 2.

FIG. 10 illustrates classes that are detected by a position estimation device according to a variation of Embodiment 2.

FIG. 11 is a flowchart illustrating operations of a learning device according to the variation of Embodiment 2.

### DESCRIPTION OF EMBODIMENTS

### Circumstances Leading to Present Disclosure

In recent years, various studies have been conducted on object detectors that detect objects around vehicles, using image data captured by an on-vehicle camera or any other device. For example, consideration is being given to the feasibility of estimating the position of a target object on the basis of image data captured by a camera. The position of a target object includes the distance from a vehicle to the target object. When, for example, a vehicle runs by automatic operation, the vehicle performs, for example, time to collision (TTC) control. The accuracy of the position of a target object is of importance to the TTC control.

For example, when the camera is a monocle, the position of a target object can be estimated using the monocle, even if a vehicle does not include a plurality of cameras. That is, the position of a target object can be estimated at lower cost. As one example of the object detector, such a position estimation device that estimates the position of a target object may be mounted on a vehicle.

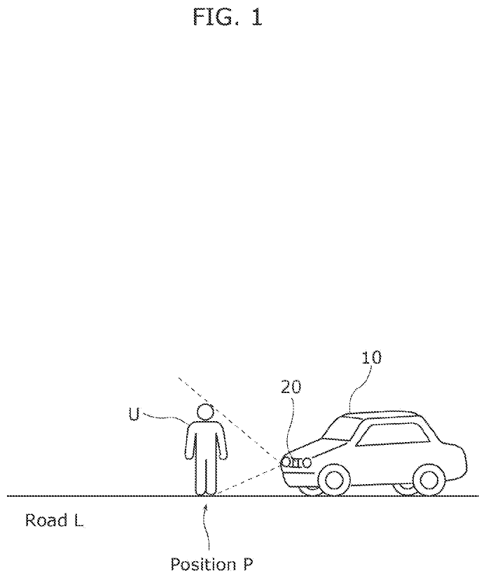

A case of estimating the position of a target object on the basis of image data captured by a camera will be described with reference to FIG. 1. FIG. 1 is a schematic diagram for describing position estimation conducted by a vehicle according to a comparative example. FIG. 1 shows an example in which pedestrian U on road L (ground) is in front of vehicle 10 provided with camera 20. Vehicle 10 is also on road L. In the example illustrated in FIG. 1, pedestrian U is on the same plane as the plane on which vehicle 10 stands. Pedestrian U is one example of the target object. Note that the position estimation device is not limited to being mounted on vehicle 10.

As illustrated in FIG. 1, for example, camera 20 of vehicle 10 is provided on the indoor side of the upper part of the windshield of vehicle 10 and captures images of the surroundings of vehicle 10, including pedestrian U in front of the vehicle. For example, camera 20 may be a monocle, but is not limited thereto.

A position estimation device (not shown) of vehicle 10 estimates the position of pedestrian U on the basis of image data captured by camera 20. For example, the position estimation device estimates the position of pedestrian U, based on the premise that the lower end of a region (“estimated box” described later) where pedestrian U is detected in the captured image data is in contact with road L. In this case, in order to estimate the position of pedestrian U with high accuracy, it is necessary to, for example, accurately detect the lower end of the region where pedestrian U is detected in the image data. In this way, in the case where a vehicle is equipped with the position estimation device, it may be desirable to particularly accurately detect the lower end of the region where pedestrian U is detected, using a learning model. Note that the lower end of the region where pedestrian U is detected is one example of a specific position.

However, NPL 1 fails to disclose the feature of accurately detecting the specific position or the like in the image data.

Although the above description gives one example of detecting the specific position, the same can be said of the detection of a specific class. For example, NPL 1 fails to disclose the feature of accurately detecting the specific class. The specific class as used herein refers to a class of a target object that is desired to be detected with particularly high accuracy. For example, in the case where the position estimation device is mounted on a vehicle, the specific class may be person. The specific position and the specific class are examples of a specific target to be detected.

As described above, it may have been difficult with conventional techniques to accurately detect the specific target to be detected. In view of this, the inventors of the present invention have eagerly considered the learning method and so on that are capable of accurately detecting the specific target to be detected, and have proposed the learning method and so on described hereinafter.

A learning method according to one aspect of the present disclosure includes acquiring a learning image and correct information, the learning image including an object, the correct information including a correct class and a correct box, the correct class indicating a class of the object, and the correct box indicating a region that includes the object in the learning image, acquiring an object detection result and calculating an evaluation value for a learning model in accordance with a difference between the correct information and the object detection result acquired, the learning model being a model that receives input of an image and outputs the object detection result, the object detection result including a detected class and a detected box, the detected class indicating a class of the object obtained by inputting the learning image to the learning model, and the detected box indicating a region that includes the object in the learning image, and adjusting a parameter of the learning model in accordance with the evaluation value calculated. The calculating of the evaluation value includes performing at least one of processing for varying a weight that is assigned to each of differences of two or more positions or two or more lengths between the correct box and the detected box, or processing for varying a weight that is assigned to a difference between the correct class and the detected class, in accordance with whether the correct class is a specific class.

Accordingly, in the calculating of the evaluation value, it is possible to vary the weights that are assigned to positions and classes to calculate evaluation values among the positions and the classes. For example, the weights are set so as to improve the accuracy of detecting the specific target to be detected. This allows the learning model to be trained such that the specific target to be detected can be detected with higher accuracy than in the case of assigning a fixed weight. Therefore, according to the present disclosure, it is possible to achieve a learning method capable of accurately detecting an object to be detected.

For example, the calculating of the evaluation value may include performing at least one of processing for varying a first weight and a second weight, the first weight being assigned to a difference of a specific position or a specific length between the correct box and the detected box, and the second weight being assigned to a difference of a position or a length other than the specific position or the specific length between the correct box and the detected box, or processing for varying a third weight and a fourth weight, the third weight being assigned to a difference between the correct class and the detected class when the correct class is the specific class, and the fourth weight being assigned to a difference between the correct box and the detected box when the correct class is other than the specific class.

Accordingly, it is possible to generate a learning model capable of accurately detecting the specific class or the specific position or length.

For example, the calculating of the evaluation value may include varying at least the first weight and the second weight, and the first weight may be greater than the second weight.

Accordingly, it is possible to generate a learning model capable of accurately detecting, in particular, the specific position or length.

For example, the calculating of the evaluation value may include setting the second weight to zero.

Accordingly, it is possible to generate a learning model capable of more accurately detecting the specific position or length.

For example, the specific position may be a position of a lower end of each of the correct box and the detected class.

Accordingly, it is possible to generate a learning model capable of more accurately detecting the position of the lower end of the detected box. Thus, when the object is a person, it is possible to generate a learning model capable of accurately detecting the foot position of the person.

For example, the calculating of the evaluation value may include varying at least the third weight and the fourth weight, and the third weight may be greater than the fourth weight.

Accordingly, it is possible to generate a learning model capable of accurately detecting, in particular, the specific class (specific label).

For example, the correct class may include a first correct class for classifying the object, and a second correct class indicating an attribute or a state of the object. The detected class may include a first detected class into which the object is classified, and a second detected class indicating an attribute or a state of the object detected. The calculating of the evaluation value may include, when the second correct class is the specific class, setting a weight that is assigned to a difference between the first correct class and the first detected class as the fourth weight, and setting a weight that is assigned to a difference between the second correct class and the second detected class as the third weight.

Accordingly, it is possible to generate a learning model capable of accurately detecting the specific class when there is a plurality of types of classes.

For example, the first weight may be a weight that is assigned to a difference of a position of a lower end between the correct box and the detected box. The second weight may be a weight that is assigned to a difference of a position of an upper end between the correct box and the detected box. The first weight may be greater than the second weight.

Accordingly, it is possible to generate a learning model capable of detecting the lower end of the detected box more accurately than detecting the upper end of the detected box.

For example, the evaluation value may be calculated by summing a first evaluation value and a second evaluation value, the first evaluation value being based on the first weight and the difference of the position of the lower end, and the second evaluation value being based on the second weight and the difference of the position of the upper end.

Accordingly, in the case where the difference of the position of the lower end and the difference of the position of the upper end are the same, the first weight is set to a larger value than the second weight, i.e., the difference of the position of the lower end has a relatively greater influence on the evaluation value. Therefore, the learning model capable of accurately detecting the position of the lower end can be generated by carrying out learning so as to reduce the evaluation value.

For example, a relationship of the first weight and the second weight may be applied when the class of the object is the specific class.

Accordingly, it is passible to generate a learning model capable of detecting the lower end of the detected box more accurately than detecting the upper end of the detected box in the case of the specific class.

For example, the learning model may be used in a position estimation device that is mounted on a vehicle and that estimates a position of the object.

Accordingly, it is possible to generate a learning model capable of accurately detecting the lower end of the object, i.e., the position where the object is on the road. This contributes to accurately calculating the distance from the vehicle to the object.

For example, the first weight may be a weight that is assigned to a difference of a length in an up-down direction between the correct box and the detected box. The second weight may be a weight that is assigned to a difference of a length in a right-left direction between the correct box and the detected box, The first weight may be greater than the second weight.

Accordingly, it is possible to generate a learning model capable of detecting the length in the up-down direction of the detected box more accurately than detecting the length in the right-left direction of the detected box.

A learning device according to one aspect of the present disclosure includes an acquirer that acquires a learning image and correct information, the learning image including an object, the correct information including a correct class and a correct box, the correct class indicating a class of the object, and the correct box indicating a region that includes the object in the learning image, an evaluator that acquires an object detection result and calculates an evaluation value for a learning model in accordance with a difference between the correct information and the object detection result acquired, the learning model being a model that receives input of an image and outputs the object detection result, the object detection result including a detected class and a detected box, the detected class indicating the class of the object obtained by inputting the learning image to the learning model, and the detected box indicating a region that includes the object in the learning image, and an adjuster that adjusts a parameter of the learning model in accordance with the evaluation value calculated. In the calculating of the evaluation value, the evaluator performs at least one of processing for varying a weight that is assigned to each of differences of two or more positions or two or more lengths between the correct box and the detected box, or processing for varying a weight that is assigned to a difference between the correct class and the detected class, in accordance with whether the correct class is a specific class. A recording medium according to one aspect of the present disclosure is a non-transitory computer-readable recording medium having recorded thereon a program for causing a computer to execute the learning method described above.

Accordingly, it is possible to achieve effects similar to those of the learning method described above.

It is to be noted that such generic or specific embodiments of the present disclosure may be implemented or realized as a system, a device, a method, an integrated circuit, a computer program, or a non-transitory recording medium such as a computer-readable CD-ROM, or may be implemented or realized as any combination of them. The program may be stored in advance in a recording medium, or may be supplied to a recording medium via a wide-area communication network including the Internet.

Hereinafter, embodiments will be described in specific details with reference to the accompanying drawings.

Each embodiment described below illustrates one generic or specific example of the present disclosure. Therefore, numerical values, shapes, constituent elements, positions of the constituent elements in the layout, forms of connection of the constituent elements, and so on in the following embodiments are mere examples and do not intend to limit the scope of the present disclosure. For example, numerical values and the ranges of numerical values are not the expressions that represent only precise meaning, but are also the expressions that mean the inclusion of substantially equivalent ranges such as differences within ranges of several percent. Among the constituent elements described in the following embodiments, those that are not recited in any independent claim, which represents the broadest concept of the present disclosure, are described as optional constituent dements.

Each drawing is a schematic diagram and is not always illustrated in precise dimensions. Thus, for example, scale reduction or the like in drawings may not always be the same.

Substantially the same constituent dements are given the same reference signs throughout the drawings, and detailed description thereof shall be omitted or simplified.

In the specification of the present disclosure, terms that indicate the relationship of elements such as being the same, terms that indicate the shapes of elements such as a rectangle, and numerical values and the ranges of numerical values are not the expressions that represent only precise meaning, but are also the expressions that mean the inclusion of substantially equivalent ranges such as differences within ranges of several percent (e.g., about 5%).

### Embodiment 1

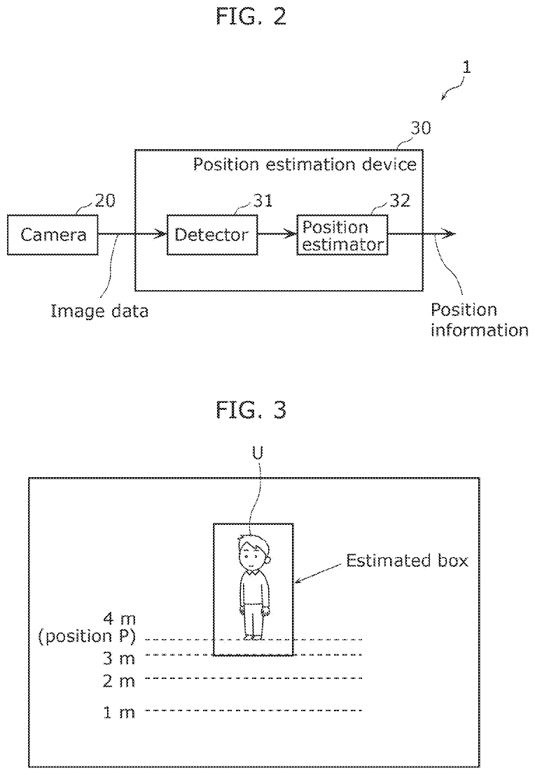

Hereinafter, a position estimation system and a learning device according to the present embodiment will be described with reference to FIGS. 2 to 7.

### 1-1. Configuration of Position Estimation System

First, a configuration of the position estimation system according to the present embodiment will be described with reference to FIG. 2. FIG. 2 is a block diagram illustrating a functional configuration of position estimation system 1 according to the present embodiment.

As illustrated in FIG. 2, position estimation system 1 includes camera 20 and position estimation device 30. Position estimation system 1 is an information processing system that estimates the position of an object (target object) seen in image data captured by camera 20 on the basis of the image data. Note that position estimation system 1 is not limited to being mounted on a movable body, and may be mounted on, for example, stationary equipment or equipment that is fixedly mounted and used at a predetermined position. The following description gives an example in which position estimation system 1 is mounted on vehicle 10, which is one example of the movable body.

Camera 20 is mounted on vehicle 10 and captures an image of the surroundings of vehicle 10. For example, camera 20 may be an on-vehicle compact camera (e.g., on-vehicle monocle) attached dose to the center of the width of the front of vehicle 10. Camera 20 is, for example, mounted forward of vehicle 10, but may be mounted on the ceiling dose to the windshield in the vehicle. Camera 20 may also be mounted so as to be capable of capturing images of the rear and lateral sides of vehicle 10.

There are no particular limitations on camera 20, and a commonly known camera may be used. For example, camera 20 may be a common visible light camera that captures images of light with wavelengths of the visible light range, but may also be a camera capable of acquiring information on infrared rays. As another alternative, camera 20 may be a wide-angle camera. As yet another alternative, camera 20 may be a fisheye camera with a fisheye lens. As yet further alternative, camera 20 may be a monochrome camera that captures monochrome images, or may be a color camera that captures color images.

Camera 20 outputs captured image data to position estimation device 30. Camera 20 is one example of an image capturing device. The image data may, for example, be two-dimensional image data.

Position estimation device 30 estimates the position of a target object on the basis of image data acquired from camera 20. Position estimation device 30 is a three-dimensional position estimation device that estimates a three-dimensional position of a target object in real space on the basis of the image data. Position estimation device 30 includes detector 31 and position estimator 32.

Detector 31 detects a target object to be detected, on the basis of image data acquired from camera 20. The following description gives an example in which classes of target objects to be detected by detector 31 include person, but the classes are not limited to person. Detector 31 functions as an acquirer that acquires image data including pedestrian U from camera 20. Pedestrian U is one example of the person.

Detector 31 receives input of image data and detects an object, using a trained model that has undergone learning so as to output an object detection result that includes the class of the detected object (in this example, a person) and an estimated box (detected box) in which an object seen in the image data, including a person, is detected. The estimated box indicates a region that includes the object in the image data, and may be a rectangular box, for example. The estimated box includes, for example, information on coordinates in the image data. The coordinate information may include, for example, coordinates of the points at diagonally opposite corners of the estimated box.

Detector 31 outputs the object detection result, which is based on the image data acquired from camera 20, to position estimator 32.

On the basis of the object detection result, position estimator 32 estimates the position of the target object and outputs position information that includes the estimated position. Position estimator 32 according to the present embodiment estimates the position of pedestrian U, based on the assumption that pedestrian U is on road L.

Specifically, position estimator 32 transforms the coordinates in the estimated box included in the detection result from coordinates in the image data (camera coordinate system) into coordinates (orthogonal coordinate system) in the real world (real space), based on the assumption that pedestrian U is on road L. The coordinates indicates the position of the target object, For example, the coordinates may indicate the position using, as a reference, vehicle 10 on which position estimation system 1 is mounted, i.e., the distance from vehicle 10 to the target object. Note that there are no particular limitations on the method of coordinate transformation, and any known method may be used.

Here, the detection of position P of pedestrian U will be described with reference to FIG. 3. FIG. 3 shows one example of the position estimation result. FIG. 3 shows an example in which actual position P of pedestrian U is 4 m.

As illustrated in FIG. 3, when detector 31 has detected that the estimated box of pedestrian U is larger than pedestrian U, position estimator 32 estimates the position of pedestrian U, assuming that the position of the lower end of the estimated box is at the position where pedestrian U is on road L (ground), In the example of FIG. 3, since position estimator 32 calculates the position of pedestrian U (the distance up to pedestrian U) from the coordinates in the image, the position of pedestrian U is calculated at 3 m. In this case, a difference in position is 1 m.

In this way, position estimator 32 calculates the position of the target object, based on the assumption that the lower end of the estimated box is on road L. Thus, the lower end of the estimated box greatly affects the accuracy of calculating the position of the target object, In the present embodiment, detector 31 uses a trained model that has undergone learning conducted by learning device 40 described later, so that it is possible to accurately detect the lower end of the estimated box, i.e., the position where pedestrian U is on road L.

### 1-2. Configuration of Learning Device

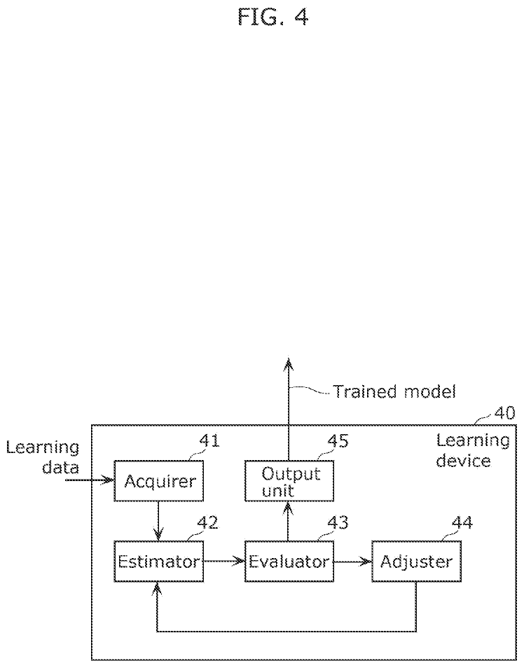

Next, learning device 40 according to the present embodiment will be described with reference to FIG. 4. FIG. 4 is a block diagram illustrating a functional configuration of learning device 40 according to the present embodiment.

As illustrated in FIG. 4, learning device 40 includes acquirer 41, estimator 42, evaluator 43, adjuster 44, and output unit 45. Learning device 40 generates a trained model for estimating positions, used in detector 31 of position estimation device 30, According to the present embodiment, learning device 40 is configured so as to be capable of generating a trained model that is capable of accurately detecting the lower end of an estimated box obtained by detecting a target object. Note that learning device 40 trains the learning model by machine learning using a data set. The learning model is one example of a machine learning model that detects an object on the basis of image data, and may, for example, be a machine learning model using a neural network such as deep learning. For example, the machine learning model may be constructed, using a convolutional neural network (CNN), regions with CNN features (R-CNN), Faster R-CNN, You Only Look Once (YOLO), or Single Shot MultiBox Detector (SSD).

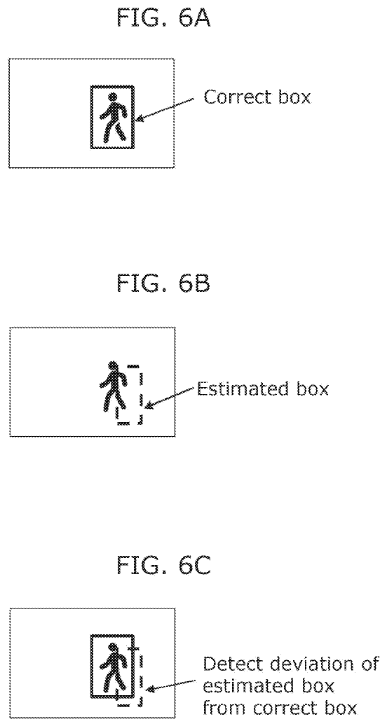

The term learning as used in the specification of the present disclosure refers to adjusting parameters of a learning model so as to reduce an evaluation value that quantifies a deviation of the estimated box (e.g., see FIG. 6B) from the correct box (e.g., see FIG. 6A), which will be described later, and a difference between a detected class and a correct class. The evaluation value indicates object detection performance of the learning model. The estimated box is also referred to as a “default box” in the SSD.

Acquirer 41 acquires learning data for training the learning model. The learning data is a data set that includes a learning image including the target object and correct information on the learning image. The learning image is used as an input image in the machine learning. The correct information is used as reference data in machine learning and may include, for example, the class of an object and the region that includes the object in the image. The data set may, for example, be a commonly known data set and is acquired from a device outside learning device 40, but the data set may be generated by learning device 40. The class of the object included in the correct information is one example of the correct class. The region in the image is a rectangular box (see FIG. 6A) and is also referred to as the correct box. For example, acquirer 41 may be configured to include a communication circuit.

Estimator 42 performs estimation processing on the learning image acquired by acquirer 41, using a learning model for estimating the object. Estimator 42 inputs the learning image to the learning model and acquires a result of estimating the object seen in the learning image. The estimation result includes the estimated box of the object and the class of the object. The estimated box included in the estimation result is one example of the detected box, and the class of the object is one example of the detected class.

Evaluator 43 calculates an evaluation value that indicates an evaluation of the learning model on the basis of the estimation result acquired from estimator 42 and the correct information included in the learning data acquired by acquirer 41. For example, evaluator 43 may calculate the evaluation value, using an evaluation function. Although the details will be described later, the present embodiment is characterized in the method of calculating the evaluation value, used in evaluator 43. Note that the following description gives an example in which the learning model achieves lower detection performance as the evaluation value increases, but the present disclosure is not limited thereto.

Adjuster 44 adjusts the learning model on the basis of the evaluation value calculated by evaluator 43. When the evaluation value is greater than or equal to a threshold value or when the number of times the series of processing is repeatedly performed by estimator 42, evaluator 43, and adjuster 44 is less than or equal to a threshold value, adjuster 44 adjusts the learning model, using the evaluation value. The adjustment of the learning model may involve, for example, adjusting at least one of weights and biases. The adjustment of the learning model may use any known method and may use, for example, an error back propagation (BP) method.

Note that whether the evaluation value is less than the threshold value and whether the number of repetitions of the processing is greater than or equal to the threshold value are examples of a predetermined condition. Adjuster 44 adjusts the learning model when the predetermined condition is not satisfied.

Estimator 42 again performs the estimation processing on the adjusted learning model. Estimator 42, evaluator 43, and adjuster 44 improve the accuracy of detecting the learning model by repeatedly making such adjustments to each of a plurality of different (e.g., several thousands of) learning images and correct information corresponding to each learning image.

Output unit 45 outputs a learning model that has an evaluation value less than a predetermined value, as a trained model. For example, output unit 45 outputs the trained model to position estimation device 30 via communication. There are no particular limitations on the method of communication between output unit 45 and position estimation device 30, and the communication may be cable communication, or may be wireless communication, There are also no particular limitations on communication standards, Output unit 45 may be configured to include, for example, a communication circuit.

Learning device 40 may further include other constituent elements such as a receiver that accepts input from a user, and a storage that stores various types of information. For example, the receiver may be implemented via a touch panel, buttons, a keyboard, or any other device, or may be configured to accept input via voice or by any other means, The storage may be implemented via a semiconductor memory or any other device, and may store, for example, various types of tables.

Note that the machine learning conducted by learning device 40 may use, for example, a learning image as the input image and use the estimated box of an object seen in the learning image and the class of the object as the correct information. The machine learning conducted by learning device 40 may, for example, use supervised data, but the present disclosure is not limited thereto.

### 1-3. Operations of Learning Device

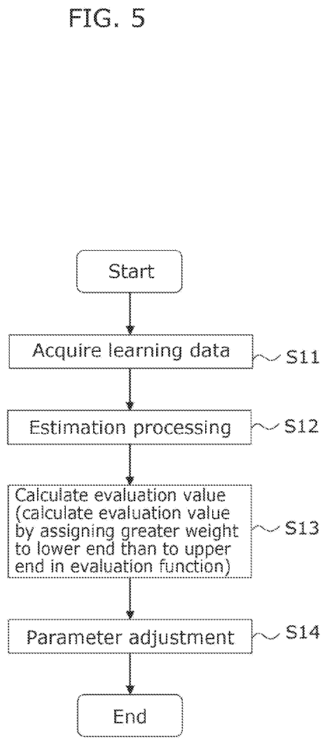

Next, operations of learning device 40 described above will be described with reference to FIGS. 5 to 7. FIG. 5 is a flowchart illustrating the operations of learning device 40 according to the present embodiment.

As illustrated in FIG. 5, acquirer 41 acquires learning data (S11). The learning data includes a learning image that includes an object, and correct information that includes a correct class and a correct box, the correct class indicating the class of an object, and the correct box indicating a region that includes the object in the learning image. For example, acquirer 41 acquires the learning data via wireless communication. The learning data may be acquired in accordance with, for example, a user's instruction. Note that the correct class, which indicates the class of an object, includes information indicating a correct answer to the class of the object and, for example, includes information indicating a correct label for the class when a plurality of labels is included in the class of an object. In the present embodiment, a label that corresponds to the object (correct label) is included in the correct class. The correct information is also referred to as annotation information.

FIG. 6A illustrates a correct box provided during learning carried out by learning device 40.

As illustrated in FIG. 6A, the learning data includes an image including a person as the learning image, and includes information indicating the correct box as the correct information. The learning data further includes the class of an object (e.g., person) seen in the learning image. Examples of the class include person, vehicle (e.g., automobile), bicycle, and motorbike, and the class is appropriately determined depending on the uses to which position estimation system 1 is put. For example, the class may include two or more pieces of information. For example, the class may indicate an object and the state of the object. For example, the class may indicate information such as a sitting person or a running vehicle. As another alternative, the class may indicate, for example, the attribute and state of the object. For example, the class may indicate information such as a sitting man. As yet another alternative, the class may indicate, for example, an object and the attribute of the object. For example, the class may indicate information such as a person in his/her twenties or a red vehicle.

These classes are also examples of the detected class indicating the class of the object, Note that the attribute is appropriately determined depending on the type of the object or other information, and examples of the attribute include gender, age, color, posture, feeling, and action.

Referring back to FIG. 5, next, estimator 42 performs estimation processing on the learning model, using the learning data (S12), Estimator 42 acquires, as an estimation result, an output obtained by inputting the learning image to the learning model, The estimation result includes an estimated box and an estimated class, Step S12 is one example of acquiring an object detection result.

FIG. 6B illustrates the estimated box output during learning carried out by learning device 40.

As illustrated in FIG. 6B, estimator 42 acquires the estimated box as a result of estimating the learning image. FIG. 6B shows an example in which the estimated box obtained by estimator 42 deviates from the person.

Referring back to FIG. 5, next, evaluator 43 calculates an evaluation value, using the estimation result (S13). Evaluator 43 acquires the object detection result and calculates an evaluation value on the basis of a difference between the acquired object detection result and the correct information. The object detection result includes the detected class and the estimated box, the detected class indicating the class of the object obtained by inputting the learning image to the learning model that receives input of an image and outputs the object detection result, and the estimated box indicating a region that includes the object in the learning image. The evaluation value is a value corresponding to the above difference.

Evaluator 43 calculates the evaluation value such that a deviation of a specific target to be detected, among targets to be detected, has a relatively greater influence on the evaluation value than deviations of the other targets to be detected have on the evaluation value. In the case where the specific target to be detected is the position of the lower end of the estimated box, evaluator 43 calculates the evaluation value by, for example, assigning a greater weight to the lower end of the estimated box than to the targets other than the lower end (e.g., upper end) in the evaluation function. For example, in the case where a deviation of the lower end of the estimated box from that of the correct box and a deviation of the upper end of the estimated box from that of the correct box are the same value, evaluator 43 calculates a larger evaluation value for the deviation of the lower end than for the derivation of the upper end. In this way, evaluator 43 makes evaluations so as to reduce the deviation of the lower end of the estimated box from that of the correct box by parameter adjustments made by adjuster 44.

FIG. 6C illustrates a deviation of the estimated box from the correct box during learning carried out by learning device 40. The solid-line box in FIG. 6C indicates the correct box in FIG. 6A, and the broken-line box in FIG. 6C indicates the estimated box in FIG. 6B.

As illustrated in FIG. 6C, the estimated box deviates from the correct box. It can also be said that evaluator 43 detects a deviation of the estimated box from the correct box. In FIG. 6C, both of the upper and lower ends of the estimated box deviate from those of the correct box. By calculating the evaluation value as described above, learning device 4 is capable of preferentially reducing the deviation of the lower end, out of the deviations of the upper and lower ends.

Note that the correct box and the estimated box are of, for example, the same shape. In the present embodiment, the correct box and the estimated box each have a rectangular shape, but the present disclosure is not limited thereto.

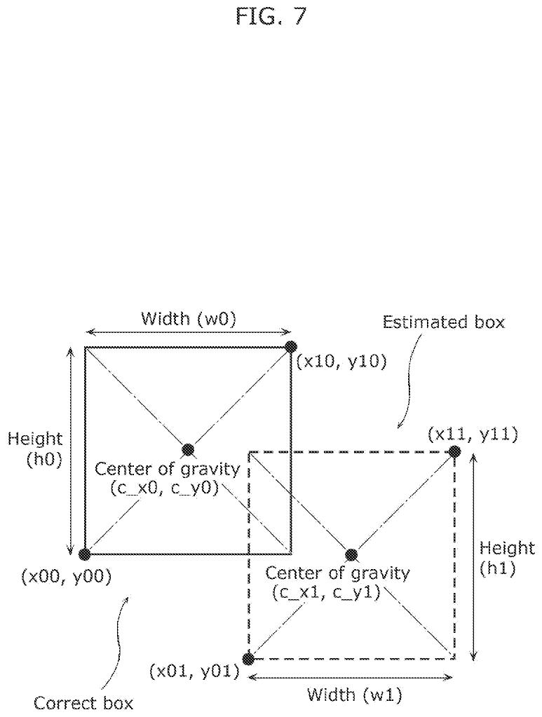

FIG. 7 is a diagram for describing a method of adjusting parameters, used in adjuster 44 according to the present embodiment. The diagram in FIG. 7 is obtained by enlarging the correct box and the estimated box illustrated in FIG. 6C and illustrating, for example, the coordinates of each position.

As illustrated in FIG. 7, the correct box has a center of gravity at coordinates (c_x0, c_y0), a width of W0, a height of h0, and diagonally opposite corners at coordinates (x00, y00) and (x10, y10).

The estimated box has a center of gravity at coordinates (c_x1, c_y1), a width of w1, a height of h1, and diagonally opposite corners at coordinates (x01, y01) and (x11, y11). Note that the center of gravity is the position of the point of intersection of diagonal lines.

A learning device according to a comparative example carries out learning so as to minimize either deviations of the coordinates of the diagonally opposite corners of the estimated box or deviations of the center of gravity, height, and width of the estimated box from those of the correct box. Thus, for example in the case where learning is carried out to minimize the deviations of the coordinates of the diagonally opposite corners of the estimated box from those of the correct box, both of the deviation of the coordinates of the lower end of the estimated box (e.g., coordinates (x11, y11)) and the deviation of the coordinates of the upper end of the estimated box (e.g., coordinates (x01, y01)) from those of the correct box are minimized. For example, the learning device according to the comparative example assigns the same weight to the difference of the coordinates of the lower end and to the difference of the coordinates of the upper end, With this learning, it is difficult to effectively improve the accuracy of detecting the coordinates of the lower end when there is a desire to accurately detect the coordinates of the lower end.

On the other hand, learning device 40 according to the present embodiment, which determines weights as described above, carries out learning so as to minimize the deviation of the coordinates of the lower end of the estimated box, among the coordinates of the diagonally opposite corners or the center of gravity, height, and width, from those of the lower end of the correct box. Thus, for example, when learning is carried out to minimize the deviations of the coordinates of the diagonally opposite corners of the estimated box from those of the correct box, it is possible to minimize the difference of the coordinates of the lower end, out of the coordinates of the lower end (e.g., coordinates (x01, y01)) and the coordinates of the upper end (e.g., coordinates (x11, y11)) by the learning. With this learning, it is possible to effectively improve the accuracy of detecting the coordinates of the lower end when there is a desire to accurately detect the coordinates of the lower end.

Note that the evaluation value based on the deviations of the coordinates of the diagonally opposite corners of the estimated box is calculated by summing a first evaluation value based on the deviation of the coordinates of the lower end and a second evaluation value based on the deviation of the coordinates of the upper end.

The first evaluation value is an evaluation value based on the deviation (difference) of the coordinates of the lower end and a first weight described later and is calculated by, for example, multiplying the deviation of the coordinates of the lower end by the first weight. The second evaluation value is an evaluation value based on the deviation (difference) of the coordinates of the upper end and a second weight described later and is calculated by, for example, multiplying the deviation of the coordinates of the upper end by the second weight. The evaluation value based on the center of gravity, height, and width of the estimated box is calculated by summing a third evaluation value based on the deviation of the center of gravity, a fourth evaluation value based on the deviation in height, and a fifth evaluation value based on the deviation in width.

Now, an evaluation function that is used in evaluation 43 to calculate the evaluation value will be described, First, the evaluation function is expressed by Expression 1 below.

Evaluation value=evaluation value for class+evaluation value for estimated box (1)

As expressed by Expression 1, the evaluation value for the learning model is calculated as a sum of the evaluation value for the class and the evaluation value for the estimated box.

In the case where the detected class does not match the correct class of the object, the evaluation value for the class is set to a higher value than in the case where the detected class matches the correct class. As the difference in position between the correct box and the estimated box increases, the evaluation value for the estimated box is set to a higher value.

Evaluator 43 calculates the evaluation value by performing at least one of processing for varying weights that are assigned to differences of two or more positions or lengths between the correct box and the estimated box or processing for varying a weight that is assigned to the difference between the correct class and the detected class in accordance with whether the correct class is a specific class. In the present embodiment, for example, evaluator 43 varies a weight that is assigned to the difference between the correct box and the estimated box in accordance with whether the difference between the correct box and the estimated box is the difference of a specific position or length. Note that the differences of two or more positions or lengths may include differences of two or more positions, differences of two or more lengths, or a difference of one or more positions and a difference of one or more lengths, Note that the weight that is assigned to the difference refers to a weight that multiplies the difference in the calculation of the evaluation value.

The specific position is a position to be accurately detected by position estimation device 30 and may, for example, be a position of importance during control of equipment or the like on which position estimation system 1 is mounted. In the case where position estimation system 1 is mounted on vehicle 10, the specific position may, for example, be the lower end of the estimated box, but the present disclosure is not limited thereto. In the present embodiment, the lower end of the estimated box indicates the foot position of a person and is used to calculate the position of the object in real space. The specific length is a length to be detected accurately by position estimation device 30 and may, for example, be a length of importance during control of equipment or the like on which position estimation system 1 is mounted. In the case where position estimation system 1 is mounted on vehicle 10, the specific length may, for example, be the length in the up-down direction of the estimated box, and the length other than the specific length may be the length in the right-left direction of the estimated box, but the present disclosure is not limited thereto. The length in the up-down direction of the estimated box is used to calculate the height of the object (e.g., stature when the object is a person).

In the calculation of the evaluation value, for example, evaluator 43 performs at least one of processing for varying the first weight and the second weight, the first weight being assigned to a difference of the specific position or length between the correct box and the estimated box, and the second weight being assigned to a difference of a position or length other than the specific position or length between the correct box and the estimated box; or processing for varying a third weight and a fourth weight, the third weight being assigned to a difference between the correct class and the detected class when the correct class is the specific class, and the fourth weight being assigned to a difference between the correct class and the detected class when the correct class is other than the specific class. In the present embodiment, evaluator 43 varies at least the first weight and the second weight. The following description gives an example of varying the first weight and the second weight, and an embodiment for varying the third weight and the fourth weight w l be described in Embodiment 2.

For example, the evaluation value for the estimated box is calculated by Expression 2 below using, for example, the coordinates illustrated in FIG. 7. Expression 2 is an expression for calculating the evaluation value for the estimated box, calculated based on the center of gravity, height, and width of the estimated box,

Evaluation value for estimated box=A×abs (c_x_correct box−c_x_estimated box)+B×abs (c_y_correct box−c_y_estimated box)+C×abs (w_correct box−w_estimated box)+D×abs (h_correct box−h_estimated box) (2)

The first term of Expression 2 indicates an absolute value for the difference of the coordinates of the center of gravity in the lateral direction between the correct box and the estimated box, and the second term indicates an absolute value for the difference of the coordinates of the center of gravity in the longitudinal direction between the correct box and the estimated box. The third term indicates an absolute value for the difference in width between the correct box and the estimated box, and the fourth term indicates an absolute value for the difference in height between the correct box and the estimated box, Note that the width is the lateral length of the box, and the height is the longitudinal length of the box. By adjusting weights A, B, C, and D, evaluator 43 is capable of effectively increasing the evaluation value when the position of importance deviates from the correct position.

In the case where the specific position is the position of the lower end of the box or where the specific length is the height of the box, e.g., in the case where the specific target to be detected is the foot position of a person or the height of the estimated box (the stature of the person), evaluator 43 sets weights B and D to larger values than weights A and C. In this case, weights B and D are examples of the first weight, and weights A and C are examples of the second weight, The values of weights B and D may be different or may be the same, and the values of weights A and C may be different or may be the same. Weights A, B, C, and D for each target to be detected other than the specific target to be detected may be different from weights A, B, C, and D for the specific target to be detected, or all of them may be the same value. That is, the relationship between the first weight and the second weight may be applied only when the class of the object is the specific class, Evaluator 43 may determine whether the class of the object is the specific class, and switch the relationship between the first weight and the second weight for calculating the evaluation value, in accordance with the result of the determination.

In the case where the specific length is the width of the box, e.g., in the case where the specific target to be detected is the width of the estimated box (the width of a person), evaluator 43 sets larger values to weights A and C than to weights B and D. In this case, weights A and C are examples of the first weight, and weights B and D are examples of the second weight.

As described above, in the present embodiment, evaluator 43 varies at least the first weight and the second weight to calculate the evaluation value for the estimated box. Evaluator 43 sets a larger value to the first weight than to the second weight, the first weight being assigned to the difference of the specific position or length between the correct box and the estimated box, and the second weight being assigned to the difference of a position or length other than the specific position or length between the correct box and the estimated box. For example, evaluator 43 sets a different value to at least one of weights A, B, C, or D when calculating the evaluation value.

Note that evaluator 43 is not limited to calculating the evaluation value for the estimated box in accordance with Expression 2. For example, in the case of carrying out a detection tailored to the foot position of a person, evaluator 43 may calculate the evaluation value for the estimated box only on the basis of the term regarding the foot position of the person. Such an expression is expressed by, for example, Expression 3 below.

Evaluation value for estimated box=abs (c_y_correct box−c_y_estimated box) (3)

In the case of accurately detecting the foot position of a person, evaluator 43 may calculate the evaluation value for the estimated box, only using c_y_correct box and c_y_estimated box, c_y_correct box indicating the coordinates of the foot position of the person in the correct box, and c_y_estimated box indicating the coordinates of the foot position of the person in the estimated box.

In this way, in the calculation of the evaluation value, evaluator 43 may set zero to the second weight, which is assigned to the difference of a position or length other than the specific position or length between the correct box and the estimated box. Expression 3 is an expression obtained by setting weight B to 1 and setting weights A, C, and D to zero in Expression 2. In this case, weight B is one example of the first weight, and weights A, C, and D are examples of the second weight.

Evaluator 43 calculates the evaluation value for the learning model by summing the evaluation value for the class and the evaluation value for the estimated box, each calculated separately.

Referring back to FIG. 5, next, adjuster 44 adjusts parameters of the learning model on the basis of the evaluation value calculated in step S13 (S14). For example, adjuster 44 adjusts parameters of the learning model when the evaluation value does not satisfy a predetermined condition. For example, adjuster 44 may determine whether the evaluation value calculated in step S13 is less than a threshold value, and perform the processing in step S14 when the evaluation value is greater than or equal to the threshold value.

Through such parameter adjustments using the evaluation value by adjuster 44, the parameters are adjusted so as to effectively reduce the deviation of the specific target (e.g., position of importance) to be detected.

When the evaluation calculated in step S13 satisfies the predetermined condition, output unit 45 outputs the learning model to position estimation device 30. Output unit 45 determines whether the evaluation value calculated in step S13 is less than a threshold value, and outputs the learning model to position estimation device 30 when the evaluation value is less than the threshold value.

As described above, evaluator 43 according to the present embodiment adjusts the weights used in the evaluation functions expressed by Expressions 2 and 3 in accordance with the information of importance (position or length of importance). Accordingly, by adjusting the parameters of the learning model so as to reduce the evaluation value, adjuster 44 is capable of effectively adjusting the parameters of the learning model and enables accurate detection of the information of importance (e.g., information that is desired to be detected accurately). Note that, upon receipt of input of the information of importance, evaluator 43 may determine each weight on the basis of a table that associates the information of importance with the weights. As another alternative, each weight may be directly input from a user.

### Embodiment 2

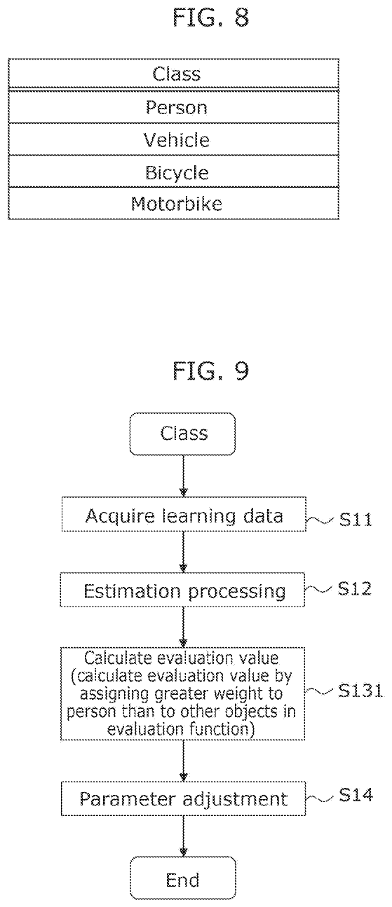

Learning device 40 according to the present embodiment will be described hereinafter with reference to FIGS. 8 and 9. Note that learning device 40 according to the present embodiment has a functional configuration similar to that of learning device 40 according to Embodiment 1, and therefore a detailed description thereof shall be omitted. FIG. 8 illustrates the class that is detected by a position estimation device according to the present embodiment, As illustrated in FIG. 8, the class includes labels named as person, vehicle, bicycle, and motorbike. In the present embodiment, an example is described in which a label of importance is included in a plurality of labels. The following description gives an example in which a specific target to be detected is a person, and greater importance is placed on person than on the other labels, FIG. 8 illustrates an object class for classifying an object as one example of the class,

### 2-1. Operations of Learning Device

Operations of learning device 40 according to the present embodiment will be described with reference to FIG. 9. FIG. 9 is a flowchart illustrating the operations of learning device 40 according to the present embodiment, Note that operations that are identical or similar to those illustrated in Embodiment 1 with reference to FIG. 5 are given the same reference signs, and descriptions thereof shall be omitted or simplified.

As illustrated in FIG. 9, evaluator 43 calculates an evaluation value, using the estimation result (S131). In the present embodiment, evaluator 43 varies at least the third weight and the fourth weight to calculate the evaluation value for the class. For example, evaluator 43 calculates the evaluation value for the class such that a deviation of the label of importance has a relatively greater influence on the evaluation value for the class than deviations of the other labels have on the evaluation value. In the calculation of the evaluation value, when the correct class is a specific class (specific label), evaluator 43 increases the weight for calculating the evaluation value for the class, as compared to the case where the correct class is not the specific class. For example, the third weight is greater than the fourth weight.

When the correct class is a specific class and the detected class is other than the specific class, evaluator 43 sets a larger value to the third weight than to the fourth weight so as to increase the evaluation value for the class, as compared to the case where the correct class is other than the specific class and the detected class is incorrect. When the correct class is other than the specific class and the detected class is the specific class, evaluator 43 may set a larger value to the fourth weight than to the third weight so as to increase the evaluation value for the class, as compared to the case where the correct class is other than the specific class and the detected class is other than the specific class and incorrect.

When the specific class (specific label) is person, e.g., when the correct class (correct label) is person and the detected class is other than person, evaluator 43 may set a larger value to the third weight than to the fourth weight, as compared to the case where the correct class is other than person and the detected class indicates a label other than the correct class. For example, it can also be said that evaluator 43 calculates the evaluation value by assigning a greater weight to person than to the other labels in the evaluation function when the specific class is person.

Evaluator 43 calculates an evaluation value for the learning model by summing the evaluation value for the class and the evaluation value for the estimated class, each calculated separately,

As described above, evaluator 43 according to the present embodiment adjusts weights in the evaluation function in accordance with the information of importance (class of importance). In this way, by adjusting the parameters of the learning model so as to reduce the evaluation value, adjuster 44 becomes capable of effectively adjusting the parameters of the learning model so that the information of importance (e.g., a class that is desired to be detected accurately) is detected with high accuracy. For example, when a plurality of labels is included in the class, learning device 40 is capable of generating a trained model with improved accuracy of detecting a specific label. The specific label is one example of the specific class,

### Variation of Embodiment 2

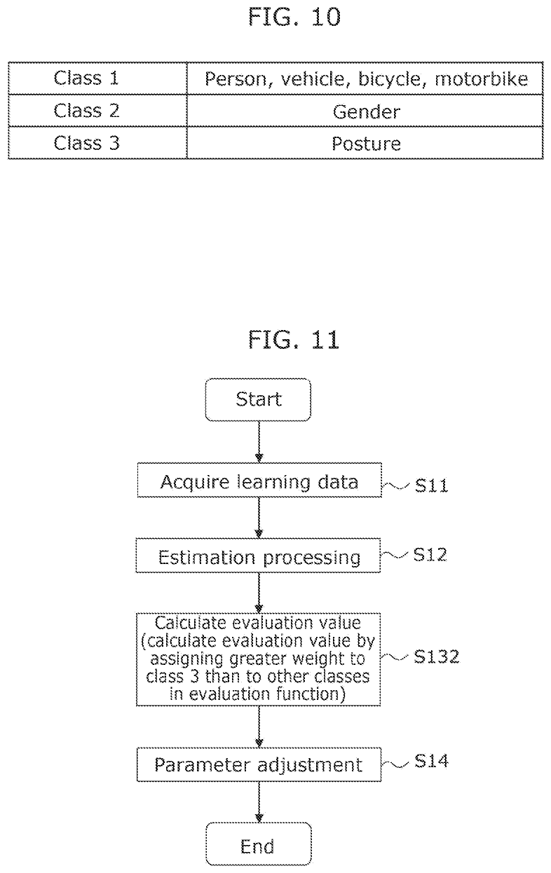

Learning device 40 according to a variation of the present embodiment will be described hereinafter with reference to FIGS. 10 and 11. Note that learning device 40 according to this variation has a functional configuration similar to that of learning device 40 according to Embodiment 1, and therefore a description thereof shall be omitted. FIG. 10 illustrates classes that serve as targets to be detected by a position estimation device according to this variation. As illustrated in FIG. 10, the classes include three classes, namely, class 1, class 2, and class 3. The three classes are included in the object detection result. Note that the number of classes is not limited to three, and may be two or more. Note that each of the classes is a different type of class.

Class 1 is a class for classifying an object and includes, for example, person, vehicle, bicycle, and motorbike. It can also be said that class 1 indicates the category of an object. Class 2 indicates the attribute of an object and includes, for example, gender when the object is a person. Class 3 indicates the state of an object and includes, for example, the posture of the object. Examples of the posture include standing, sleeping, and squatting, but the present disclosure is not limited thereto.

In this case, in the detection class for the learning model, the detection result for class 1 is “Person”, the detection result for class 2 is “Man”, and the detection result for class 3 is “Standing”.

In this way, when there is a plurality of classes, it may be desired to more accurately detect a specific class than detecting the other classes. The following description gives an example in which class 3, among classes 1 to 3, is detected more accurately than the other classes. Class 3 is one example of the specific target to be detected (specific class).

Next, operations of learning device 40 according to this variation will be described with reference to FIG. 11. FIG. 11 is a flowchart illustrating the operations of learning device 40 according to this variation. Note that operations that are identical or similar to those illustrated in Embodiment 2 with reference to FIG. 9 are given the same reference signs, and descriptions thereof shall be omitted or simplified.

As illustrated in FIG. 11, evaluator 43 calculates an evaluation value, using the estimation result (S132). According to this variation, evaluator 43 calculates an evaluation value such that a deviation of the class of importance, among a plurality of detected classes, has a relatively greater influence on the evaluation value for the class than deviations of the other classes have on the evaluation value for the class. In the calculation of the evaluation value, when class 3 is a specific class, evaluator 43 assigns a greater weight to the difference between the correct class and the detected class for class 3 than to the difference between the correct class and the detected class for classes other than class 3. In the example illustrated in FIG. 10, evaluator 43 calculates the evaluation value by assigning a greater weight to class 3, among classes 1 to 3, than to the other classes (each of classes 1 and 2).

In this way, the correct class includes class 1 for classifying an object (one example of the first correct class) and class 2 or 3 that indicates the attribute or state of the object (one example of the second correct class). The detected class includes a first detected class into which an object is classified, and a second detected class indicating the attribute or state of the detected object. When one of the first correct class and the second correct class is a specific class, evaluator 43 sets a weight that is assigned to a difference of the one class from the corresponding detected class as the third weight, and sets a weight that is assigned to a difference between the other class and the corresponding detected class as the fourth weight. In the calculation of the evaluation value, for example, when the second correct class is the specific class and the first correct class is other than the specific class, evaluator 43 sets a weight that is assigned to a difference between the first correct class and the first detected class as the fourth weight, and sets a weight that is assigned to the difference between the second correct class and the second detected class as the third weight. That is, in the calculation of the evaluation value, evaluator 43 assigns a greater weight to the difference between the second correct class and the second detected class than to the difference between the first correct class and the first detected class.

Note that the first correct class is not limited to the class for classifying an object, and the second correct class is not limited to the class indicating the attribute or state of the object. It is only necessary for the first and second correct classes to be of different types of classes. For example, the first correct class and the second correct class may include different labels.

Evaluator 43 calculates an evaluation value for the learning model by summing the evaluation values for the classes and the evaluation value for the estimated box, each calculated separately,

As described above, evaluator 43 according to this variation adjusts the weights used in the evaluation function in accordance with the information of importance (class of importance among a plurality of classes). In this way, by adjusting the parameters of the learning model so as to reduce the evaluation value, adjuster 44 is capable of effectively adjusting the parameters of the learning model such that the information of importance (e.g., class that is desired to be detected accurately) can be detected with high accuracy.

### Other Embodiments

Although the learning method and so on according to one or a plurality of embodiments have been described thus far with reference the embodiments and the variation, the present disclosure is not intended to be limited thereto. The present disclosure may also include other variations obtained by applying various changes conceivable by those skilled in the art to each embodiment and other variations obtained by any combination of constituent elements and functions described in each embodiment without departing from the scope of the present disclosure.

For example, in the embodiments and the variation described above, the adjuster adjusts the parameters of the learning model on the basis of the result of determination as to whether the evaluation value obtained by summing the evaluation value for the class and the evaluation value for the estimated box is less than a threshold value (first threshold value), but the present disclosure is not limited thereto. The adjuster may adjust the parameters of the learning model on the basis of the result of determination as to whether either the evaluation value for the class or the evaluation value for the estimated box is less than a threshold value (second threshold value). For example, the adjuster may determine whether the evaluation value calculated to include the evaluation value for the specific target to be detected (one of the evaluation value for the class and the evaluation value for the estimated box) is less than the second threshold value, and may adjust the parameters of the learning model when this evaluation value is greater than or equal to the second threshold value.

Although the embodiments and the variation described above have given examples in which the correct box and the estimated box have a rectangular shape, the shape of each box is not limited to the rectangular shape.

Although the variation of Embodiment 2 described above has given an example in which class 2 indicates gender, the present disclosure is not limited thereto. For example, class 2 may include at least one of age (e.g., in his/her teens, in his/her twenties), skin color, or adult or child. Although the variation of Embodiment 2 described above has given an example in which class 3 indicates posture, the present disclosure is not limited thereto, and class 3 may include at least one of feeling, facial expression, or action.

Although the embodiments and the variation given above have described the calculation of the evaluation value during learning, the present disclosure is also applicable to the calculation of an evaluation value for relearning a trained model.

Although the embodiments and the variation given above have described an example in which the learning model is a machine learning model using a neural network such as deep learning, the learning model may be any other machine learning model. For example, the machine learning model may be a machine learning model using Random Forest, Genetic Programming, or the like.

In the embodiments and the variation described above, each constituent dement may be configured by dedicated hardware, or may be implemented by executing a software program suitable for the constituent element. As another alternative, each constituent element may be implemented by a program executor such as a CPU or a processor reading out and executing a software program recorded on a hard disk or on a recording medium such as a semiconductor memory.

The sequence of execution of the steps in each flowchart is merely one example in order to specifically describe the present disclosure, and may be a sequence other than the sequence described above. Some of the steps described above may be executed simultaneously (in parallel) with other steps, or some of the steps described above may not be executed.

The way of dividing the functional blocks in each block diagram is merely one example, and a plurality of functional blocks may be realized by a single functional block, or one functional block may be divided into a plurality of functional blocks, or some functions may be transferred to a different functional block. The functions of a plurality of functional blocks that have similar functions may be processed in parallel or in time sequence by single hardware or software.

The learning device according to the embodiments and the variation described above may be implemented via a single device, or may be implemented via a plurality of devices. In the case where the learning device is implemented via a plurality of devices, each constituent element of the learning device may be divided in any way into the plurality of devices. At least one of the constituent elements of the learning device may be implemented via a server device. In the case where the learning device is implemented via a plurality of devices, there are no particular limitations on the method of communication among devices that include this learning device, and the method of communication may be wireless communication, or may be cable communication. As another alternative, wireless communication and cable communication may be combined and used among such devices.

Each constituent element described in the embodiments and the variation described above may be implemented via software, or may be implemented typically via LSI serving as an integrated circuit. These constituent elements may be individually formed into a single chip, or some or all of the constituent elements may be formed into a single chip. Although LSI is described here as an example, it may also be referred to as IC, system LSI, super LSI, or ultra LSI depending on the degree of integration. The method of circuit integration is not limited to LSI, and may be implemented via a dedicated circuit or a general-purpose processor. A field programmable gate array (FPGA) that enables programming after the manufacture of LSI, or a reconfigurable processor capable of reconfiguring connections or settings of circuit cells inside LSI may be used. Moreover, if any other circuit integration technique that replaces LSI makes its debut with the advance of semiconductor technology or with derivation from other technology, such a technique may be used to integrate the constituent elements into an Integrated circuit.

The system LSI is a super-multi-function LSI manufactured by integrating a plurality of processors on a single chip, and is specifically a computer system that is configured to include, for example, a microprocessor, a read only memory (ROM), and a random access memory (RAM). The ROM stores computer programs. The system LSI achieves its functions as a result of the microprocessor operating in accordance with computer programs.

One aspect of the present disclosure may be a computer program that causes a computer to execute each characteristic step included in the learning method described with reference to, for example, FIGS. 5, 9, and 11, For example, the program may be a program to be executed by a computer, Another aspect of the present disclosure may be a non-transitory computer-readable recording medium that records such a program. For example, such a program may be recorded on a recording medium and circulated or distributed. For example, it is possible to cause a device including a different processor to perform each processing described above, by installing a distributed program in the device and causing the different processor to execute the program.

While various embodiments have been described herein above, It is to be appreciated that various changes in form and detail may be made without departing from the spirit and scope of the present disclosure as presently or hereafter claimed.

Further Information about Technical Background to this Application

The disclosure of the following patent application including specification, drawings, and claims is incorporated herein by reference in theft entirety: Japanese Patent Application No. 2021-050042 filed on Mar. 24, 2021.

### INDUSTRIAL APPLICABILITY

The present disclosure is effective for a learning device that generates a machine learning model for estimating, for example, the position of a target object, using image data captured by a camera.

1. A learning method comprising:
acquiring a learning image and correct information, the learning image including an object, the correct information including a correct class and a correct box, the correct class indicating a class of the object, and the correct box indicating a region that includes the object in the learning image;
acquiring an object detection result and calculating an evaluation value for a learning model in accordance with a difference between the correct information and the object detection result acquired, the learning model being a model that receives input of an image and outputs the object detection result, the object detection result including a detected class and a detected box, the detected class indicating a class of the object obtained by inputting the learning image to the learning model, and the detected box indicating a region that includes the object in the learning image; and
adjusting a parameter of the learning model in accordance with the evaluation value calculated,
wherein the calculating of the evaluation value includes performing at least one of:
processing for varying a weight that is assigned to each of differences of two or more positions or two or more lengths between the correct box and the detected box; or
processing for varying a weight that is assigned to a difference between the correct class and the detected class, in accordance with whether the correct class is a specific class.

2. The learning method according to claim 1,
wherein the calculating of the evaluation value includes performing at least one of:
processing for varying a first weight and a second weight, the first weight being assigned to a difference of a specific position or a specific length between the correct box and the detected box, and the second weight being assigned to a difference of a position or a length other than the specific position or the specific length between the correct box and the detected box; or
processing for varying a third weight and a fourth weight, the third weight being assigned to a difference between the correct class and the detected class when the correct class is the specific class, and the fourth weight being assigned to a difference between the correct box and the detected box when the correct class is other than the specific class.

3. The learning method according to claim 2,
wherein the calculating of the evaluation value includes varying at least the first weight and the second weight, and
the first weight is greater than the second weight.

4. The learning method according to claim 2,
wherein the calculating of the evaluation value includes setting the second weight to zero.

5. The learning method according to claim 2,
wherein the specific position is a position of a lower end of each of the correct box and the detected class.

6. The learning method according to claim 2,
wherein the calculating of the evaluation value includes varying at least the third weight and the fourth weight, and the third weight is greater than the fourth weight,

7. The learning method according to claim 2,
wherein the correct class includes a first correct class for classifying the object, and a second correct class indicating an attribute or a state of the object,
the detected class includes a first detected class into which the object is classified, and a second detected class indicating an attribute or a state of the object detected, and
the calculating of the evaluation value includes, when the second correct class is the specific class, setting a weight that is assigned to a difference between the first correct class and the first detected class as the fourth weight, and setting a weight that is assigned to a difference between the second correct class and the second detected class as the third weight.

8. The learning method according to claim 2,
wherein the first weight is a weight that is assigned to a difference of a position of a lower end between the correct box and the detected box,
the second weight is a weight that is assigned to a difference of a position of an upper end between the correct box and the detected box, and
the first weight is greater than the second weight.

9. The learning method according to claim 8,
wherein the evaluation value is calculated by summing a first evaluation value and a second evaluation value, the first evaluation value being based on the first weight and the difference of the position of the lower end, and the second evaluation value being based on the second weight and the difference of the position of the upper end.

10. The learning method according to claim 8,
wherein a relationship of the first weight and the second weight is applied when the class of the object is the specific class.

11. The learning method according to claim 8,
wherein the learning model is used in a position estimation device that is mounted on a vehicle and that estimates a position of the object.

12. The learning method according to claim 2,
wherein the first weight is a weight that is assigned to a difference of a length in an up-down direction between the correct box and the detected box,
the second weight is a weight that is assigned to a difference of a length in a right-left direction between the correct box and the detected box, and
the first weight is greater than the second weight.

13. A learning device comprising:
an acquirer that acquires a learning image and correct information, the learning image including an object, the correct information including a correct class and a correct box, the correct class indicating a class of the object, and the correct box indicating a region that includes the object in the learning image;
an evaluator that acquires an object detection result and calculates an evaluation value for a learning model in accordance with a difference between the correct information and the object detection result acquired, the learning model being a model that receives input of an image and outputs the object detection result, the object detection result including a detected class and a detected box, the detected class indicating the class of the object obtained by inputting the learning image to the learning model, and the detected box indicating a region that includes the object in the learning image; and
an adjuster that adjusts a parameter of the learning model in accordance with the evaluation value calculated,
wherein, in the calculating of the evaluation value, the evaluator performs at least one of:
processing for varying a weight that is assigned to each of differences of two or more positions or two or more lengths between the correct box and the detected box; or
processing for varying a weight that is assigned to a difference between the correct class and the detected class, in accordance with whether the correct class is a specific class.

14. A non-transitory computer-readable recording medium having recorded thereon a program for causing a computer to execute the learning method according to claim 1.
